(19) United States
(12) Patent Application Publication
(10) Pub. No.: US 2018/0096280 A1
(43) Pub. Date: Apr. 5, 2018

(54) SKILL SET MAPPING FOR PROJECTS

(71) Applicant: INTERNATIONAL BUSINESS MACHINES CORPORATION, Armonk, NY (US)

(72) Inventors: Yi-Min Chee, Yorktown Heights, NY (US); Blain A. Dillard, Cary, NC (US); David A. Hoffman, Raleigh, NC (US); Ta-Hsin Li, Danbury, CT (US)

(21) Appl. No.: 15/281,609

(22) Filed: Sep. 30, 2016

(51) Int. Cl. G06Q 10/06; G06Q 10/10; G06F 17/30

(52) U.S. Cl. CPC G06Q 10/063112; G06Q 10/063118; G06F 17/3053; G06Q 10/103

(57) ABSTRACT

A method includes reading project data describing a plurality of projects in a project database. The plurality of projects are associated with a plurality of skill sets, where each project of the plurality of projects is associated with a skill set needed to complete the project. A set of principal skill sets is determined, to include a set of frequent skill subsets that each appear in the plurality of skill sets with at least a threshold frequency. A new project is received and associated with a requested skill set. The requested skill set is mapped, using a computer processor, to a corresponding principal skill set of the set of principal skill sets, where the corresponding principal skill set represents the requested skill set. The corresponding principal skill set is used for at least one of staffing the new project and updating organizational staffing plans related to the plurality of projects.

### BACKGROUND

Embodiments of the present invention relate to project management and, more specifically, to skill set mapping for projects.

A large project, such as construction of a building or creation of a software application, requires a project manager to assess the overall effort and create a work breakdown structure of work items that must be accomplished to deliver a finished product. For example, a software-development project can be dissected into individual assignments and associated deliverables, which can be further broken down into one or more work items. Each work item requires the project manager to identify the right resource (e.g., person) with appropriate skills to perform the work item and to deliver the outcome. Thus, staffing is a critical part of project success, and the project manager needs a capacity management and planning strategy to ensure that demand from projects for resources can be met.

### SUMMARY

According to an embodiment of this disclosure, a computer-implemented method includes reading project data describing a plurality of projects in a project database. The plurality of projects are associated with a plurality of skill sets, where each project of the plurality of projects is associated with a skill set needed to complete the project. A set of principal skill sets is determined. This determination includes determining a set of frequent skill subsets, each of which appears in the plurality of skill sets with at least a threshold frequency; and including the set of frequent skill subsets in the set of principal skill sets. A new project is received and is associated with a requested skill set. The requested skill set is mapped, using a computer processor, to a corresponding principal skill set of the set of principal skill sets, where the corresponding principal skill set represents the requested skill set. The corresponding principal skill set is used for at least one of staffing the new project and updating organizational staffing plans related to the plurality of projects.

In another embodiment, a system includes a memory having computer readable instructions and one or more processors for executing the computer readable instructions. The computer readable instructions include reading project data describing a plurality of projects in a project database. The plurality of projects are associated with a plurality of skill sets, where each project of the plurality of projects is associated with a skill set needed to complete the project. Further according to the computer readable instructions, a set of principal skill sets is determined. This determination includes determining a set of frequent skill subsets, each of which appears in the plurality of skill sets with at least a threshold frequency; and including the set of frequent skill subsets in the set of principal skill sets. A new project is received and is associated with a requested skill set. The requested skill set is mapped to a corresponding principal skill set of the set of principal skill sets, where the corresponding principal skill set represents the requested skill set. The corresponding principal skill set is used for at least one of staffing the new project and updating organizational staffing plans related to the plurality of projects.

In yet another embodiment, a computer program product for staffing projects includes a computer readable storage medium having program instructions embodied therewith. The program instructions are executable by a processor to cause the processor to perform a method. The method includes reading project data describing a plurality of projects in a project database. The plurality of projects are associated with a plurality of skill sets, where each project of the plurality of projects is associated with a skill set needed to complete the project. Further according to the method, a set of principal skill sets is determined. This determination includes determining a set of frequent skill subsets, each of which appears in the plurality of skill sets with at least a threshold frequency; and including the set of frequent skill subsets in the set of principal skill sets. A new project is received and is associated with a requested skill set. The requested skill set is mapped to a corresponding principal skill set of the set of principal skill sets, where the corresponding principal skill set represents the requested skill set. The corresponding principal skill set is used for at least one of staffing the new project and updating organizational staffing plans related to the plurality of projects.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a diagram of a mapping system, according to some embodiments of this invention;

FIG. 2 is a flow diagram of a method for determining principal skill sets of projects in a project database, according to some embodiments of this invention;

FIG. 3A is a flow diagram of operations performed by an analyzer of the mapping system, according to some embodiments of this invention;

FIG. 3B is a flow diagram of operations performed by a skill ranker of the mapping system, according to some embodiments of this invention;

FIG. 3C is a flow diagram of operations performed by a set ranker of the mapping system, according to some embodiments of this invention;

FIG. 4 is a flow diagram of a method for making organizational decisions based on a new project having a requested skill set, according to some embodiments of this invention; and

FIG. 5 is a block diagram of a computer system for implementing some or all aspects of the mapping system, according to some embodiments of this disclosure.

### DETAILED DESCRIPTION

Conventionally, a requested skill set associated with a new project is likely to contain redundant elements due to human error or over-classification, such that unnecessary or insignificant skills are included in the requested skill set. While a wide range of skills are often requested for new projects, many of these skills are not needed on the projects for which they are requested, or are likely to already be held by existing staffers with other skills. This makes identifying staffers meeting true skill requirements difficult, and also limits the pool of available staffers to those having skills that may not be necessary. The result of these noisy skill sets is a poor use of resources with respect to capacity planning and staff selection.

Turning now to an overview of aspects of the present invention, embodiments include a mapping system that trains itself on projects described in a project database, thereby identifying principal skill sets used in the projects. In some embodiments, the principal skill sets are those that occur frequently in the projects in the projects database. Each principal skill set may be ranked based on size and the importance of its contained skills, as will be described in more detail below. When a new project is presented with a requested skill set, the mapping system may map the requested skill set to the highest ranking principal skill set contained within the requested skill set. The principal skill set identified may then be used for staffing the new project, as the principal skill set is likely to contain less noise than the originally requested skill set. The principal skill set may also be an input into organizational staffing plans and decisions, and the organization may be able to staff on the most important skills rather than be distracted by skills in the requested skill sets that contain more noise.

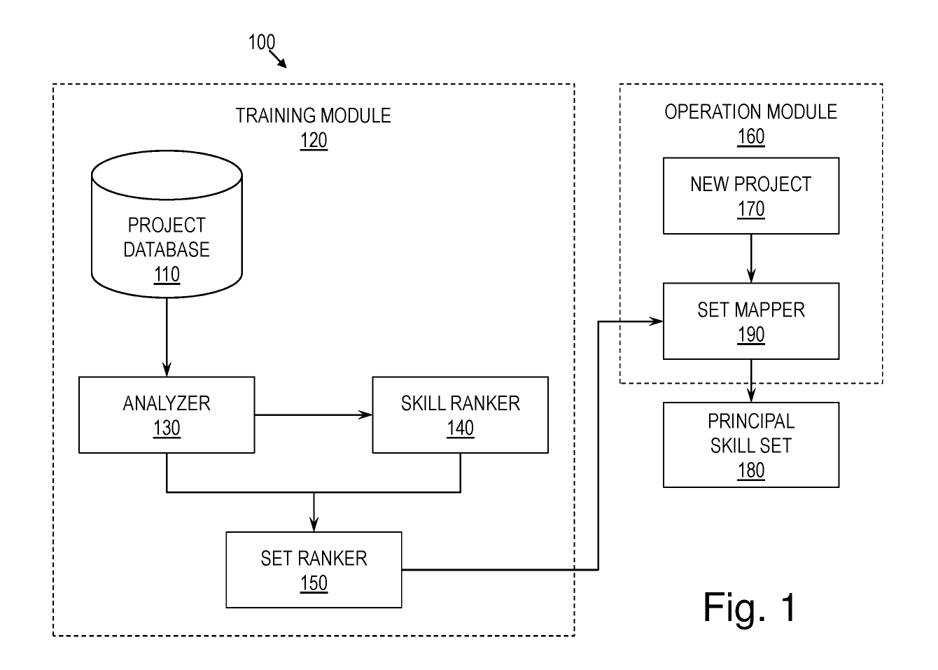

FIG. 1 is a diagram of a mapping system 100 according to embodiments of the invention. As shown in FIG. 1, the mapping system 110 includes a project database 110, a training module 120, and an operation module 160. Generally, the training module 120 trains on project data in the project database 110 to determine and order a set of principal skill sets 180, and the operation module 160 maps each new project 170 to an appropriate principal skill set 180. Each of the training module 120 and the operation module 160 include hardware, software, or a combination of both. Further, while these components are illustrated as distinct, the training module 120 and operation module 160 may share hardware, software, or both.

The training module 120 includes an analyzer 130, a skill ranker 140, and a set ranker 150. Generally, the analyzer analyzes the project data in the project database 110, the skill ranker 140 ranks skills used by projects in the project database, and the set ranker 150 ranks principal data sets, as will be described further below. The operation module can include a set mapper 190, which maps a requested skill set of a new project 170 to a principal skill set 180.

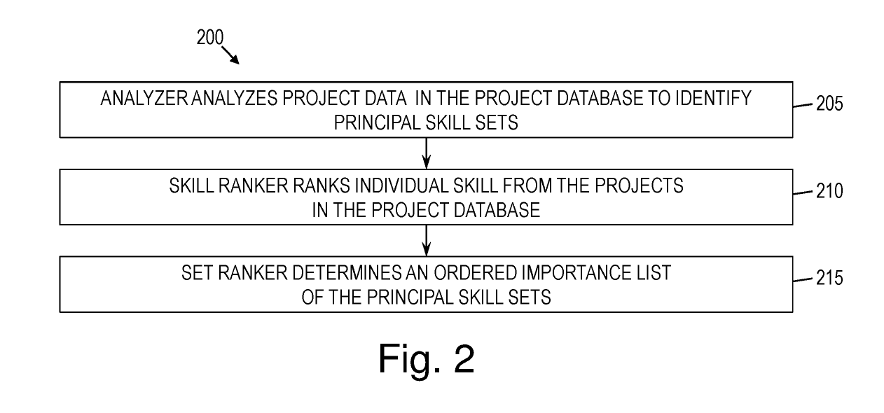

FIG. 2 is a flow diagram of a method 200 for determining principal skill sets 180, according to some embodiments of this invention. As shown in FIG. 2, at block 205, the analyzer 130 of the mapping system 100 may analyze project data in the project database 110 to identify two or more principal skill sets.

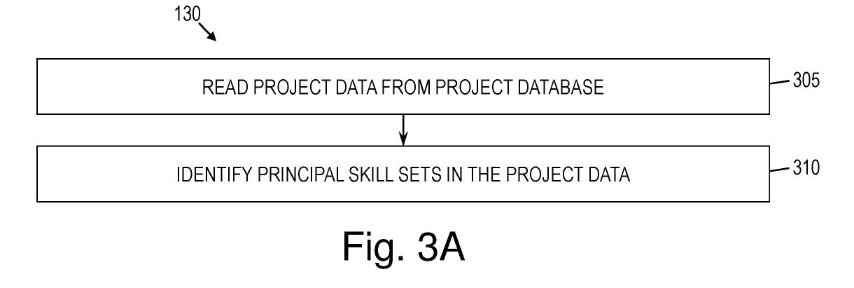

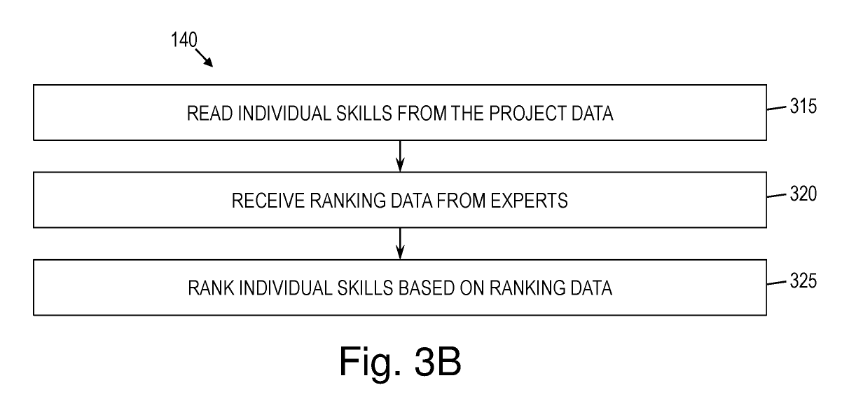

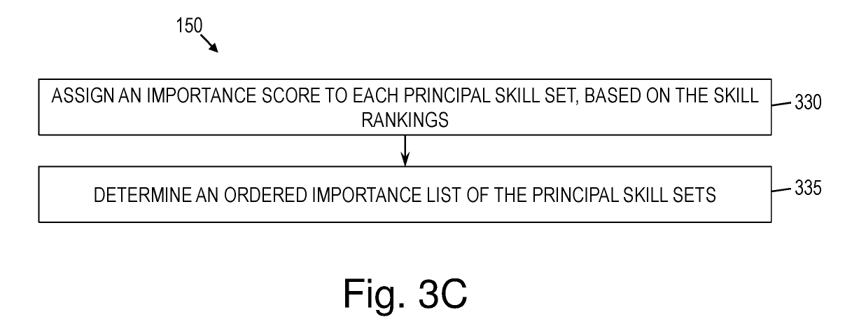

FIG. 3A is a flow diagram of operations performed by the analyzer 130, according to some embodiments of this invention. As shown in FIG. 3A, at block 305, the analyzer 130 may read project data from the project database 110. The project data may include information describing projects. These may include historical projects, which have already completed, or anticipated projects, which have not yet begun or are in progress, or a combination of both. For each historical project, the project data may include a project identifier (ID), date completed, and a skill set of skills needed to complete the project. For each anticipated project, the project data may include a project ID, if assigned, as well as a skill set of skills anticipated as needed to complete the project.

At block 310, the analyzer 130 may identify in the project data two or more principal skill sets 180. A principal skill set 180 may be defined as a subset of skills from the projects of the project database 110, where that subset of skills appears in the projects a number of times that is no less than a usage threshold, or where that subset of skills is contains no more than an individual skill. In some embodiments, for a subset of skills having more than one skill to qualify as a principal skill set 180, it is required to meet the usage threshold within a selected time interval, or to meet the usage threshold on average within each time interval. In other words, in such embodiments, a principal skill set 180 must appear in the projects of the project database 110 with a frequency meeting a frequency threshold, or the principal skill set 180 must contain only one skill.

To identify the principal skill sets 180 that contain more than a single skill each, the analyzer 130 may select a subset of skills appearing in at least one project, and may count the number of projects in which that subset of skills appears within the project database 110. If that count is at least the usage threshold, then that subset of skills may be deemed a principal skill set 180. In some embodiments, each subset of skills appearing together in a project in the project database 110 is considered as a potential principal skill set 180, and those meeting the usage threshold may be classified as principal skill sets 180.

As will be described further below, a skill set requested for a new project 170 may be mapped to one of these principal skill sets 180, and the mapped-to principal skill set 180 may be used for various purposes, such as determining how to staff the new project 170, determining cross-project staffing, or playing a role in other organizational decision-making related to projects. A justification for using principal skill sets 180 is that requested skill sets are likely to include noise in the form of skills that are not truly necessary or are redundant when included with other skills in the requested skill set. Principal skill sets 180, which are deemed common due to having met the usage threshold, or due to being individual skills, are likely to include less noise than a skill set that is not a principal skill set 180.

The value of the usage threshold may affect the noisiness of the resulting principal skill sets 180 and, thus, the usefulness of the principal skill sets 180 when new projects 170 are presented with requested skill sets. When the usage threshold is too high, important and non-noisy sets of skills may end up weeded out of the principal skill sets 180, and thus the principal skill sets may not fully represent the skill sets in the project database 110. As a result, a requested skill set may be mapped to an unnecessarily small principal skill set (e.g., a single skill), and the appropriate people may not end up staffed on new projects 170. However, when the usage threshold is too low, the principal skill sets 180 may be too noisy, and may thus be less useful in determining which skills should be used when staffing new projects 170. Thus, an administrator of the mapping system 100 may be careful to select an appropriate value of the usage threshold, and may tweak the usage threshold until results meet the administrator's requirements.

Referring back to FIG. 2, at block 210, the skill ranker 140 of the mapping system 100 may rank individual skills from the projects of the project database 110. These skill rankings may later be used by the set ranker 150 to order the principal skill sets in an importance list. In some embodiments, this block 210 is independent of block 205 and may thus be performed before block 205, or in parallel with it. FIG. 3B is a flow diagram of operations performed by the skill ranker 140, according to some embodiments of this invention.

As shown in FIG. 3B, at block 315, the skill ranker 140 may read skills from the project data in the project database 110. Specifically, for instance, the skill ranker 140 may extract from each project the skills that were required or anticipated to be required for completing the project.

At block 320, the skill ranker 140 may receive ranking data from one or more experts, where the ranking data includes information about how to rank the skills. Specifically, the ranking data may include a ranking function mapping each skill to a rank among the complete set of skills, or the ranking data may include a pairwise precedence ranking for each pair of skills in the complete set of skills. At block 325, the skill ranker 140 may determine a precedence ranking of the skills, based on the ranking data received from the experts.

In some embodiments, the precedence ranking of the skills in the project data is extracted directly from the ranking data, when the experts provide a ranking function mapping each skill to a rank. Specifically, for example, the ranking data may include a ranking function R that maps a complete set of skills S={S₁, S₂, . . . , S_{M}} from the projects in the project database 110 to a ranking set P={R₁, R₂, . . . , R_{M}}, where each Rᵢ≦M, and where each Rᵢ is the ranking of the corresponding S₁ among the set of skills. The ranking set P may be a permutation of integers {1, 2, . . . M}. In some embodiments, a lower integer represents a higher ranking, while a higher integer represents a lower ranking, but the reverse may be true in other embodiments.

In some embodiments, however, the ranking data includes pairwise precedence rankings, rather than the ranking function itself. The skill ranker 140 may then determine the ranking function based on the pairwise precedence rankings. In some embodiments, to develop this ranking data, for each pair of skills, each expert is asked which skill of the pair is more important. Importance may be defined as having the heaviest influence on a potential project. For example, for a Skill A and a Skill B that are both specialized, Skill A may be ranked higher than Skill B when Skill A is more representative of work that needs to be performed when both skills are needed. When a pair of skills is considered not specialized, the skill that is rarer among workers may be ranked higher.

For example, proficiency with the Spring™ framework would be a more limiting skill than Java® and thus considered more important because a developer who knows Spring will also know Java, but not necessarily vice versa. For another example, when comparing Java and Hypertext Markup Language (HTML), Java could be deemed more important because a developer who knows Java is likely to know HTML or to be able to learn it easily.

In some embodiments, each ranking within a pair is represented in the ranking data by a pairwise precedence value P, where P(A, B)=1 if Skill A ranks higher than Skill B, where P(A, B)=0 if Skill B ranks higher than Skill A, and where P(A, B)=0.5 if no ranking is available between the two skills. When the pairwise precedence scores are provided by multiple experts, each pair may be given a final pairwise precedence score that is an average of the pairwise precedence scores across the experts.

As mentioned above, the desired ranking function R to be determined from the ranking data maps the complete set of skills S={S₁, S₂, . . . , S_{M}} to a ranking set P={R₁, R₂, . . . , R_{M}}, where P may be a permutation of integers {1, 2, . . . M}. Because P is a permutation of the integers {1, 2, . . . M}, P may be selected from among all possible permutations of these integers. In some embodiments, to determine P, an agreement score is determined for each such permutation, where the agreement score is an indication of how well the permutation agrees with the pairwise precedence rankings, which have already been averaged as needed. The permutation with the highest agreement score may be selected as the final ranking function R.

For each possible permutation, the corresponding agreement score may be the sum of P(A, B) for each pair {A, B} in the permutation for which Skill A is ranked higher (e.g., has a lower corresponding integer) in the permutation. To determine this agreement score, for example, the mapping system 100 may extract a set of ordered pairs corresponding to the permutation, where each ordered pair represents a ranking of the first element over the second element in the permutation. Thus, for each permutation, there may be a total of (M−1)! such ordered pairs, with each combination of two skills being represented in an ordered pair that represents the order of those two skills in the permutation. The agreement score for the permutation may be initialized to a value of 0. For each ordered pair {A, B} that is extracted from the permutation, the mapping system 100 may add the value of the pairwise precedence score P(A, B) to agreement score. After all such ordered pairs have been considered, the resulting agreement score may be used as the agreement score for the permutation.

The permutation with the highest agreement score may be taken as the ranking function R. This ranking function R may represent rankings of the various skills in the projects of the project database 110, as described above. In some embodiments, a heuristic is used to determine R, rather than the deterministic technique described above.

Referring back to FIG. 2, at block 215, the set ranker 150 of the mapping system 100 may determine an ordered importance list of the principal skill sets. Later, this ordered importance list may be used to map requested skill sets to principal skill sets. FIG. 3C is a flow diagram of operations performed by the set ranker 150 of the mapping system, according to some embodiments of this invention.

As shown in FIG. 3C, at block 330, the set ranker 150 may assign an importance score to each principal skill set 180, based in part on the ranking function R. Generally, a principal skill set 180 with more skills may receive a higher importance score than a principal skill set 180 with fewer skills, because the principal skill set 180 with more skills can be considered more restrictive and thus more important for the purpose of staffing projects. Additionally, the rankings of the skills within a skill set may play a role in determining the importance score for the overall principal skill set 180. The mechanism for calculating importance scores for the principal skill sets 180 may vary across implementations.

In some embodiments, the importance score T of a principal skill set Q={S₁, . . . Sₙ} is T(Q)==Σₖ₌₁ⁿ(M−R(Sₖ)), where R(Sₖ) is the rank of Sₖ, and where M is the total number of skills in the projects of the project database 110. Because a low value of R(Sₖ) for a skill represents a high rank in some embodiments, and because M−R(Sₖ) is high for low values of R(Sₖ), the value of T is thus high for principal skill sets 180 with highly ranked skills versus those with lower ranked skills, and principal skill sets 180 with more skills have the potential for higher importance scores because more values are added to the sum.

In some embodiments, the importance score T of a principal skill set Q={S₁, . . . Sₙ} is T(Q)=(max_{1≦k≦n}(M−R(Sₖ)))× n. In other words, T may be based on the highest ranked skill in the principal skill set 180, multiplied by the total number of skills in the principal skill set 180. With this technique, once again, principal skill sets 180 with many skills have the potential for higher importance scores, as do principal skill sets 180 with highly ranked skills.

At block 335, the set ranker 150 may determine an ordered importance list of the principal skill sets 180, based in part on the importance scores. In some embodiments, the importance list need not be based solely on the importance scores, such that it is possible for a lower scoring principal skill set 180 to be ordered before a higher scoring principal skill set 180.

In the importance list, the principle skill sets may be ordered on two levels. At a high level, the principal skill sets 180 may be ordered based on the number of skills in each principal skill set 180. According to some embodiments, throughout the importance list, for a first principal skill set 180 with n skills and a second principal skill set 180 with m skills, where n>m, the first principal skill set 180 is placed before the second principal skill set 180. On a low level, the principal skill sets 180 may be ordered based on their importance scores. According to some embodiments, for two principal skill sets 180 having the same number of skills, the principal skill set 180 with the higher importance score is placed before the principal skill set 180 with the lower importance score. The importance list may behave as a ranking of principal skill sets 180, such that a first principal skill sets 180 appearing before a second in the importance list may be deemed to be higher ranked than the second.

Referring back to FIG. 2, blocks 205 through 215 represent training operations. The various training operations may be performed or updated as new projects 170, historical or anticipated, are added to the project database 110. For example, in some embodiments, these training operations may be performed periodically or when a predetermined number of additional projects have been added to the project database 110 since the last time the training operations were performed. Thus, the importance list of principal skill sets 180 may change dynamically as projects are added to the project database.

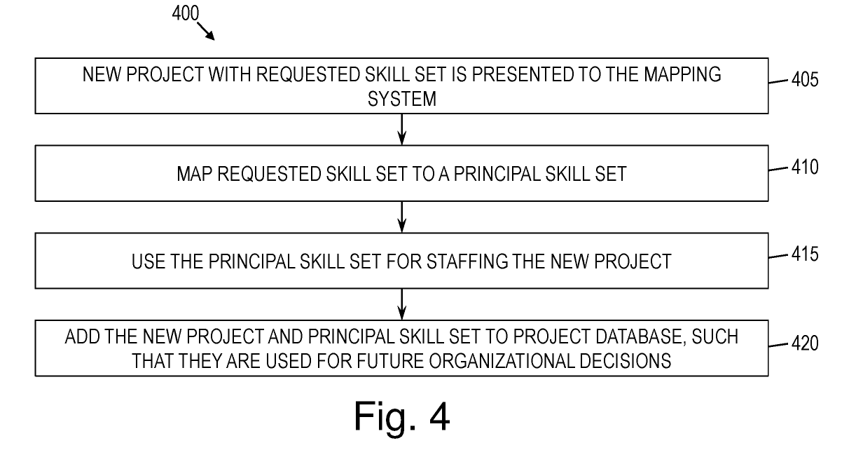

FIG. 4 is a flow diagram of a method 400 for making organizational decisions based on a new project 170 having a requested skill set, according to some embodiments of this invention. In some embodiments, this method 400 may be performed for each new project 170 introduced to the mapping system 100. In some embodiments, this method 400 is performed by the operation module 160 and, specifically, by the set mapper 190. Further, the blocks of this method 400 may be performed after at least an initial pass through the blocks of the method 200 in FIG. 2, described above.

As shown in FIG. 4, at block 405, a new project 170 may be presented to the mapping system 100, where the new project 170 is associated with a requested skill set. The requested skill set may be the skills requested, and presumably believed needed, for the new project 170.

At block 410, the requested skill set may be mapped to a principal skill set 180. Specifically, in some embodiments, if the requested skill set is equal to one of the principal skill sets 180, then the requested skill set may be mapped to that principal skill set 180. However, if the requested skill set is not a principal skill set 180, the requested skill set may be mapped to the first principal skill set 180 (i.e., the highest ranked) in the importance list that is fully contained by the requested skill set. In other words, the principal skill set 180 to which the requested skill set is mapped may be a subset of the requested skill set, and may be the highest ranked subset in the importance list. Thus, in cases where no multi-element principal skill set 180 is contained within the requested skill set, the requested skill set may be mapped to the highest-ranking individual skill in the requested skill set.

At block 415, the principal skill set 180 to which the requested skill set is mapped may be used for staffing the new project 170. If not already a principal skill set 180, the requested skill set is likely to be noisy, and thus the principal skill set 180 may represent the requested skill set with decreased noise. As a result, staffing may be performed accurately, but potentially more efficiently, when using the principal skill set 180 rather than the requested skill set. To staff the new project 170, a set of staffers may be selected such that each skill in the principal skill set 180 is appropriately covered.

At block 420, the new project may be added to the project database 110 in association with the principal skill set 180 to which it was mapped. In this manner, the new project may therefore be included in later organizational decisions, such as cross-project staffing, as well as future determinations of principal skills sets and rankings. As the mapping system 100 continues to operate over time, the mapping system 100 may evolve based on the new projects 170 introduced and added to the project database 110. For example, and not by way of limitation, as multiple projects are introduced as new projects 170 and added to the project database 110, the mapping system 100 may be used to determine whether adequate personnel are available to handle the anticipated projects in the project database 110. If not, then additional personnel may be hired to ensure coverage of the principal skill sets 180.

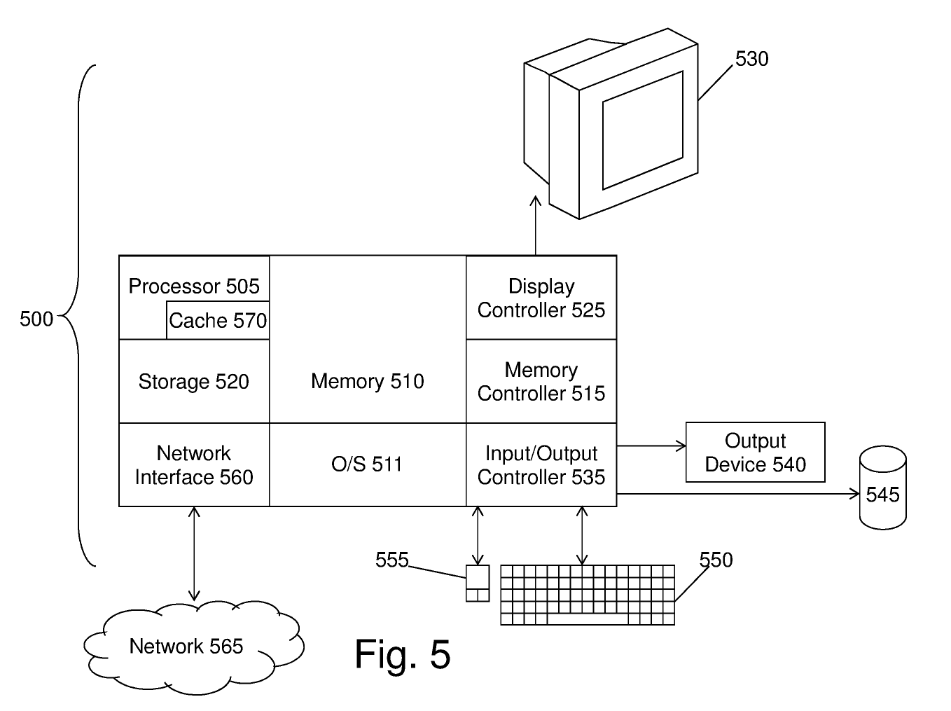

FIG. 5 illustrates a block diagram of a computer system 500 for use in implementing a mapping system 100 or method according to some embodiments. The mapping systems 100 and methods described herein may be implemented in hardware, software (e.g., firmware), or a combination thereof. In some embodiments, the methods described may be implemented, at least in part, in hardware and may be part of the microprocessor of a special or general-purpose computer system 500, such as a personal computer, workstation, minicomputer, or mainframe computer.

In some embodiments, as shown in FIG. 5, the computer system 500 includes a processor 505, memory 510 coupled to a memory controller 515, and one or more input devices 545 and/or output devices 540, such as peripherals, that are communicatively coupled via a local I/O controller 535. These devices 540 and 545 may include, for example, a printer, a scanner, a microphone, and the like. Input devices such as a conventional keyboard 550 and mouse 555 may be coupled to the I/O controller 535. The I/O controller 535 may be, for example, one or more buses or other wired or wireless connections, as are known in the art. The I/O controller 535 may have additional elements, which are omitted for simplicity, such as controllers, buffers (caches), drivers, repeaters, and receivers, to enable communications.

The I/O devices 540, 545 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 505 is a hardware device for executing hardware instructions or software, particularly those stored in memory 510. The processor 505 may be a custom made or commercially available processor, a central processing unit (CPU), an auxiliary processor among several processors associated with the computer system 500, a semiconductor based microprocessor (in the form of a microchip or chip set), a macroprocessor, or other device for executing instructions. The processor 505 includes a cache 570, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 570 may be organized as a hierarchy of more cache levels (L1, L2, etc.).

The memory 510 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 510 may incorporate electronic, magnetic, optical, or other types of storage media. Note that the memory 510 may have a distributed architecture, where various components are situated remote from one another but may be accessed by the processor 505.

The instructions in memory 510 may include one or more separate programs, each of which comprises an ordered listing of executable instructions for implementing logical functions. In the example of FIG. 5, the instructions in the memory 510 include a suitable operating system (OS) 511. The operating system 511 essentially may control the execution of other computer programs and provides scheduling, input-output control, file and data management, memory management, and communication control and related services.

Additional data, including, for example, instructions for the processor 505 or other retrievable information, may be stored in storage 520, which may be a storage device such as a hard disk drive or solid state drive. The stored instructions in memory 510 or in storage 520 may include those enabling the processor to execute one or more aspects of the mapping systems 100 and methods of this disclosure.

The computer system 500 may further include a display controller 525 coupled to a display 530. In some embodiments, the computer system 500 may further include a network interface 560 for coupling to a network 565. The network 565 may be an IP-based network for communication between the computer system 500 and an external server, client and the like via a broadband connection. The network 565 transmits and receives data between the computer system 500 and external systems. In some embodiments, the network 565 may be a managed IP network administered by a service provider. The network 565 may be implemented in a wireless fashion, e.g., using wireless protocols and technologies, such as WiFi, WiMax, etc. The network 565 may also be a packet-switched network such as a local area network, wide area network, metropolitan area network, the Internet, or other similar type of network environment. The network 565 may be a fixed wireless network, a wireless local area network (LAN), a wireless wide area network (WAN) a personal area network (PAN), a virtual private network (VPN), intranet or other suitable network system and may include equipment for receiving and transmitting signals.

Mapping systems 100 and methods according to this disclosure may be embodied, in whole or in part, in computer program products or in computer systems 500, such as that illustrated in FIG. 5.

Technical effects and benefits of some embodiments include the ability to filter insignificant, or noisy, skills from a requested skill set for a new project 170 by way of mapping to a commonly used skill set, referred to herein as a principal skill set 180. As a result, the requested skill set may be reduced to a manageable level for capacity and management planning.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
training, by a training module device, wherein the training comprises:
reading project data describing a plurality of projects in a project database, wherein the plurality of projects are associated with a plurality of skill sets, and wherein each project of the plurality of projects is associated with a skill set needed to complete the project; and
determining a set of frequent skill subsets, each of which comprises two or more skills and each of which appears in the plurality of skill sets with at least a threshold frequency;
determining a set of principal skill sets based on the set of frequent skill subsets, wherein each principal skill set in the set of principal skill sets comprises two or more skills and is among the set of frequent skill subsets; and
performing, by an operation module device, at least one of staffing a new project and updating organizational staffing plans related to the plurality of projects, wherein the performing comprises:
receiving a new project associated with a requested skill set;
removing a redundancy in the requested skill set by mapping, using a computer processor, the requested skill set to a corresponding principal skill set of the set of principal skill sets, wherein the corresponding principal skill set to which the requested skill set is mapped is a frequent skill subset appearing in the plurality of skill sets and represents the requested skill set, wherein the removing the redundancy comprises:
determining, for each principal skill set in the set of principal skill sets, a count of skills that are distinct in the principal skill set and an importance of each skill in the principal skill set;
wherein at least one principal skill set in the set of principal skill sets comprises two or more skills that are distinct;
ranking each principal skill set in the set of principal skill sets, wherein the ranking of each principal skill set is based at least in part on the count of the respective two or more skills in the principal skill set that are distinct and the importance of each skill in the principal skill set;
identifying one or more principal skill sets, from among the set of principal skill sets, that are subsets of the requested skill set; and
selecting, as the corresponding principal skill set to which the requested skill set is mapped, from among the one or more principal skills sets that are subsets of the requested skill set, a highest ranked principal skill set that is a subset of the requested skill set; and
using the corresponding principal skill set to which the requested skill set is mapped for the at least one of staffing the new project and updating organizational staffing plans related to the plurality of projects.

2. The computer-implemented method of claim 1, wherein the determining the set of principal skill sets further comprises adding to the set of principal skill sets each individual skill of the plurality of skills, wherein each individual skill is included as a distinct principal skill set in the set of principal skill sets.

3. The computer-implemented method of claim 1, wherein the ranking each principal skill set in the set of principal skill sets comprises:
ranking a plurality of skills in the set of principal skill sets, wherein the importance of each skill is based on the ranking of the plurality of skills, wherein each principal skill set comprises a subset of the plurality of skills;
scoring each principal skill set, of the set of principal skill sets, based on the ranking of the plurality of skills and based on which skills of the plurality of skills appear in the principal skill set; and
ranking the set of principal skills sets based on the scoring of the set of principal skill sets.

4. (canceled)

5. (canceled)

6. The computer-implemented method of claim 1, wherein the ranking the plurality of skills in the set of principal skill sets comprises:
determining a plurality of pairwise rankings, comprising a pairwise ranking for each pair of skills in the plurality of skills; and
ranking the plurality of skills based on the plurality of pairwise rankings.

7. The computer-implemented method of claim 6, wherein the determining the plurality of pairwise rankings comprises:
receiving, from each of a plurality of experts, a pairwise ranking for each pair of skills in the plurality of skills; and
for each pair of skills in the plurality of skills, averaging the pairwise rankings received for the pair of skills from the plurality of experts.

8. A system comprising:
a training module device configured to train, wherein the training comprises:
reading project data describing a plurality of projects in a project database, wherein the plurality of projects are associated with a plurality of skill sets, and wherein each project of the plurality of projects is associated with a skill set needed to complete the project;
determining a set of frequent skill subsets, each of which comprises two or more skills and each of which appears in the plurality of skill sets with at least a threshold frequency;
determining a set of principal skill sets based on the set of frequent skill subsets, wherein each principal skill set in the set of principal skill sets comprises two or more skills and is among the set of frequent skill subsets; and
an operation module device configured to perform at least one of staffing a new project and updating organizational staffing plans related to the plurality of projects, wherein the performing comprises:
receiving a new project associated with a requested skill set;
removing a redundancy in the requested skill set by mapping the requested skill set to a corresponding principal skill set of the set of principal skill sets, wherein the corresponding principal skill set to which the requested skill set is mapped is a frequent skill subset appearing in the plurality of skill sets and represents the requested skill set, wherein the removing the redundancy comprises:
determining, for each principal skill set in the set of principal skill sets, a count of skills that are distinct in the principal skill set and an importance of each skill in the principal skill set;
wherein at least one principal skill set in the set of principal skill sets comprises two or more skills that are distinct;
ranking each principal skill set in the set of principal skill sets, wherein the ranking of each principal skill set is based at least in part on the count of the respective two or more skills in the principal skill set that are distinct and the importance of each skill in the principal skill set;
identifying one or more principal skill sets, from among the set of principal skill sets, that are subsets of the requested skill set; and
selecting, as the corresponding principal skill set to which the requested skill set is mapped, from among the one or more principal skills sets that are subsets of the requested skill set, a highest ranked principal skill set that is a subset of the requested skill set; and
using the corresponding principal skill set to which the requested skill set is mapped for at least one of staffing the new project and updating organizational staffing plans related to the plurality of projects.

9. The system of claim 8, wherein the determining the set of principal skill sets further comprises adding to the set of principal skill sets each individual skill of the plurality of skills, wherein each individual skill is included as a distinct principal skill set in the set of principal skill sets.

10. The system of claim 8, wherein the ranking each principal skill set in the set of principal skill sets comprises:
ranking a plurality of skills in the set of principal skill sets, wherein the importance of each skill is based on the ranking of the plurality of skills, wherein each principal skill set comprises a subset of the plurality of skills;
scoring each principal skill set, of the set of principal skill sets, based on the ranking of the plurality of skills and based on which skills of the plurality of skills appear in the principal skill set; and
ranking the set of principal skills sets based on the scoring of the set of principal skill sets.

11. (canceled)

12. (canceled)

13. The system of claim 8, wherein the ranking the plurality of skills in the set of principal skill sets comprises:
determining a plurality of pairwise rankings, comprising a pairwise ranking for each pair of skills in the plurality of skills; and
ranking the plurality of skills based on the plurality of pairwise rankings.

14. The system of claim 13, wherein the determining the plurality of pairwise rankings comprises:
receiving, from each of a plurality of experts, a pairwise ranking for each pair of skills in the plurality of skills; and
for each pair of skills in the plurality of skills, averaging the pairwise rankings received for the pair of skills from the plurality of experts.

15. A computer-program product for staffing projects, the computer program product comprising a computer readable storage medium having program instructions embodied therewith, the program instructions executable by a processor to cause the processor to perform a method comprising:
training, by a training module device, wherein the training comprises:
reading project data describing a plurality of projects in a project database, wherein the plurality of projects are associated with a plurality of skill sets, and wherein each project of the plurality of projects is associated with a skill set needed to complete the project; and
determining a set of frequent skill subsets, each of which comprises two or more skills and each of which appears in the plurality of skill sets with at least a threshold frequency;
determining a set of principal skill sets based on the set of frequent skill subsets, wherein each principal skill set in the set of principal skill sets comprises two or more skills and is among the set of frequent skill subsets; and
performing, by an operation module device, at least one of staffing a new project and updating organizational staffing plans related to the plurality of projects, wherein the performing comprises:
receiving a new project associated with a requested skill set;
removing a redundancy in the requested skill set by mapping the requested skill set to a corresponding principal skill set of the set of principal skill sets, wherein the corresponding principal skill set to which the requested skill set is mapped is a frequent skill subset appearing in the plurality of skill sets and represents the requested skill set, wherein the removing the redundancy comprises:
determining, for each principal skill set in the set of principal skill sets, a count of skills that are distinct in the principal skill set and an importance of each skill in the principal skill set;
wherein at least one principal skill set in the set of principal skill sets comprises two or more skills that are distinct;
ranking each principal skill set in the set of principal skill sets, wherein the ranking of each principal skill set is based at least in part on the count of the respective two or more skills in the principal skill set that are distinct and the importance of each skill in the principal skill set;
identifying one or more principal skill sets, from among the set of principal skill sets, that are subsets of the requested skill set; and
selecting, as the corresponding principal skill set to which the requested skill set is mapped, from among the one or more principal skills sets that are subsets of the requested skill set, a highest ranked principal skill set that is a subset of the requested skill set; and
using the corresponding principal skill set to which the requested skill set is mapped for the at least one of staffing the new project and updating organizational staffing plans related to the plurality of projects.

16. The computer-program product of claim 15, wherein the determining the set of principal skill sets further comprises adding to the set of principal skill sets each individual skill of the plurality of skills, wherein each individual skill is included as a distinct principal skill set in the set of principal skill sets.

17. The computer-program product of claim 15, wherein the ranking each principal skill set in the set of principal skill sets comprises:
ranking a plurality of skills in the set of principal skill sets, wherein the importance of each skill is based on the ranking of the plurality of skills, wherein each principal skill set comprises a subset of the plurality of skills;
scoring each principal skill set, of the set of principal skill sets, based on the ranking of the plurality of skills and based on which skills of the plurality of skills appear in the principal skill set; and
ranking the set of principal skills sets based on the scoring of the set of principal skill sets.

18. (canceled)

19. (canceled)

20. The computer-program product of claim 15, wherein the ranking the plurality of skills in the set of principal skill sets comprises:
determining a plurality of pairwise rankings, comprising a pairwise ranking for each pair of skills in the plurality of skills; and
ranking the plurality of skills based on the plurality of pairwise rankings.

21. The computer-program product of claim 20, wherein the determining the plurality of pairwise rankings comprises:
receiving, from each of a plurality of experts, a pairwise ranking for each pair of skills in the plurality of skills; and
for each pair of skills in the plurality of skills, averaging the pairwise rankings received for the pair of skills from the plurality of experts.
